(19) United States
(12) Patent Application Publication
(10) Pub. No.: US 2023/0305124 A1
(43) Pub. Date: Sep. 28, 2023

(54) METHODS AND SYSTEMS OF WINDOW BLOCKAGE DETECTION FOR LIDAR

(71) Applicant: Innovusion, Inc., Sunnyvale, CA (US)

(72) Inventors: Peng Wan, San Jose, CA (US); Gang Zhou, San Jose, CA (US); Zheng Yang, Los Altos, CA (US); Yufeng Li, Milpitas, CA (US)

(73) Assignee: Innovusion, Inc., Sunnyvale, CA (US)

(21) Appl. No.: 18/124,526

(22) Filed: Mar. 21, 2023

Related U.S. Application Data
(60) Provisional application No. 63/324,008, filed on Mar. 25, 2022.

(51) Int. Cl. G01S 7/497; G01S 17/931

(52) U.S. Cl. CPC G01S 7/497; G01S 17/931; G01S 2007/4975

(57) ABSTRACT

A Light Detection and Ranging (LiDAR) scanning system, having a window blockage detector, aids in delivering reliable point cloud data associated with surroundings during instances of window blockage. A laser source within the system may generate one or more beams of light transmitted through a window, scanning the surroundings for external objects. The window blockage detector couples to receive scattered light from the window, as well as returning light from an object in the path of one or more light beams. From the scattered and returning light pulses, the window blockage detector having a thresholding method determines a window state relative to a select one of the following states including, unblocked, blocked, and null; wherein the null state exists when the beam of light intersects an empty sky or a highly absorbent object. Thereby, the LiDAR system provide a more accurate picture of a vehicles surrounding.

### CROSS-REFERENCE TO RELATED APPLICATIONS

This application claims priority to U.S. Provisional Patent Application Ser. No. 63/324,008, filed Mar. 25, 2022, entitled “METHODS AND SYSTEMS OF WINDOW BLOCKAGE DETECTION FOR LIDAR,” the content of which is hereby incorporated by reference in its entirety for all purposes.

### FIELD OF THE TECHNOLOGY

This disclosure relates generally to optical scanning and, more particularly, to detecting a window blockage of a light detection and ranging (LiDAR) system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminates an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

Embodiments of a system and window blockage detection method for LiDAR is provided. It should be appreciated that the present embodiment can be implemented in numerous ways, such as a process, an apparatus, a system, a device, or a method. Several inventive embodiments are described below.

The present disclosure provides a window blockage detection method for LiDAR, which enables LiDAR to detect window blockage state in real time online. As an important part of the autonomous driving perception system, LiDAR is mainly responsible for providing the vehicle computing center with real time and reliable point cloud data so that the vehicle can perceive the surroundings. However, when the window of a LiDAR system is at least partially blocked, the LiDAR system can no longer provide effective information for the vehicle computing center. A window of a LiDAR system normally allows light to be transmitted to illuminate objects within a field-of-view (FOV). Return light also passes through the window and is received by a receiver of the LiDAR system. If the vehicle computing center incorrectly uses information provided by LiDAR when the window is at least partially blocked, a wrong decision can be made, leading to possible serious consequences. Therefore, LiDAR window blockage detection is of great significance to the vehicle safety and to the reliability of a vehicle perception system.

In some embodiments, a method of performing window blockage detection for a LiDAR system is provided. The method includes generating one or more beams of light using a laser source within the LiDAR system. For example, the LiDAR system includes a laser source that generates the light beam. In another step, the method may include transmitting, using the optical component, the beam of light through a window. For example, the LiDAR system may include an optical steering mechanism that couples to receive the beam of light. The LiDAR system may include a window positioned adjacent to a recess within the housing of the LiDAR system, where the optical steering mechanism steers the light beam through the window. After the light beam hits an object and is reflected back towards the window of the LiDAR system, the method may include receiving both scattered light and a return light pulse. For example, window blockage detector can couple to receive the reflected light pulse from the object in the FOV. The window blockage detector can also couple to receive the light that is scattered from the light beam hitting the window. The method may further include determining a window state that identifies whether the window is blocked or not, based upon the received scattered and return light pulse. Moreover, the method may include generating, based upon the detected window state, a notification and sending the notification to a vehicle perception and planning system of a vehicle.

In some embodiments, a LiDAR system, having window blockage detection performed by a processor-based window blockage detector is provided. The system comprises a laser source for generating a beam of light. The laser source couples to an optical device having a window blockage detector and an optical transceiver. In some examples, the optical transceiver may comprise an optical receiver and an optical transmitter. In some examples, the LiDAR system includes housing having a recess; wherein, a window couples to the housing adjacent to the recess. In some examples, the window is seated within the recess of the housing. The optical transceiver couples to receive and transmit the beam of light through the window. After the light beam is sent, the optical transceiver couples to receive scattered light from the window, as well as reflected light pulse from an object in the path of a beam of light. The window blockage detector couples to the optical transceiver to detect a window state relative to whether the window is blocked. In some examples, the window state can be a select one of the following states including, unblocked, blocked, and null; wherein the null state exists when the beam of light intersects an empty sky or a highly absorbent object. The LiDAR system further comprises an electronic generator for converting the returning light into a digital electronic signal to be sent to a vehicle perception and planning system for guided driver automation based upon the detected one of three window states. The electronic generator may be, for example, a photodetector.

In some embodiments, a tangible, non-transitory, computer-readable media having instructions whereupon which, when executed by a processor, cause the processor to perform the window blockage detection method for LiDAR described herein. The method includes controlling the generating of one or more beams of light using a laser source within the LiDAR system. For example, the LiDAR system includes a laser source that generates the light beam. In another step, the method may include controlling the transmitting of, using the optical component, the beam of light through a window. For example, the LiDAR system may include an optical steering mechanism that couples to receive the beam of light. The LiDAR system may include a window positioned adjacent to a recess within the housing of the LiDAR system, where the optical steering mechanism steers the light beam through the window. After the light beam hits an object and is reflected back towards the window of the LiDAR system, the method may include controlling the receiving of both scattered light and a return light pulse. For example, window blockage detector can couple to receive the return light pulse from the object in the path of a beam of light. The window blockage detector can also couple to receive the light that is scattered from the light beam hitting the window. The method may further include determining a window state that identifies whether the window is blocked or not, based upon the received scattered and return light pulse. Moreover, the method may include generating, based upon the detected window state, a notification and sending the notification to a vehicle perception and planning system of a vehicle.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems, having window blockage detection capabilities, disposed or included in a motor vehicle.

FIG. 2 is a block diagram illustrating interactions between an example LiDAR system and multiple other systems including a vehicle perception and planning system, in accordance with some examples.

FIG. 3A is a block diagram illustrating an example LiDAR system, having window blockage detection capabilities, in accordance with some examples.

FIG. 3B is a block diagram of an optical receiver and light detector of the example LiDAR system of FIG. 3A.

FIG. 4 is a block diagram illustrating an example fiber-based laser source, in accordance with some examples.

FIG. 5A shows an example LiDAR system using pulse signals to measure distances to objects disposed in a field-of-view (FOV) without the window being blocked.

FIG. 5B illustrates the example LiDAR system of FIG. 5A, wherein the window is partially blocked with an obstructing object.

FIG. 5C shows the example LiDAR system of FIG. 5B with pulse signals of Region A showing a return light pulse from the obstructing object and scattered light from the window.

FIG. 6A is a graph of the results of an Analog-to-Digital Converter (ADC) configured to generate digital signals representing light received by the LiDAR system shown in FIG. 5B where a blocked window exists, wherein a sampling pulse of the optical signals associated with the scattered light verses the sample number is plotted, according to some examples.

FIG. 6B is a graph of the results of an ADC configured to generate digital signals representing light received by the LiDAR system shown in FIG. 5A where a blocked window does not exist, wherein a sampling pulse of the optical signals associated with the return pulse and scattered light verses the sample number is plotted, according to some examples.

FIG. 7 is a graphical depiction of the whole Field Of View (FOV) divided into meshes of an m by n grid in accordance with the Galvanometer mirror scanning angle and the polygon mirror scanning angle of the LiDAR system shown in FIG. 3A, according to some examples.

FIG. 8A shows a first example of a partially blocked window of a LiDAR system, according to some examples.

FIG. 8B shows a representative grid of the partially blocked window of a LiDAR system in FIG. 8A, illustrating the associated calculated blockage flags, according to some examples.

FIG. 8C shows a second example of a partially blocked window of a LiDAR system of two obstructing objects, according to some examples.

FIG. 8D shows a representative grid of the partially blocked window of a LiDAR system in FIG. 8C, illustrating the associated calculated blockage flags, according to some examples.

FIG. 9A is a flow diagram of a method for detecting the blocked window state of a LiDAR system, having window blockage detection capabilities, of FIGS. 3A-3B, in accordance with some embodiments.

FIG. 9B is a flow diagram of a method for detecting whether the window is fully blocked or partially blocked of the method shown in FIG. 9A, in accordance with some embodiments.

FIG. 10 displays an illustration showing an example of a computing device which may implement the examples described herein.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

As an important sensor of the autonomous driving perception system, a LiDAR system is mainly responsible for providing the vehicle computing center with real time and reliable point cloud data so that the vehicle can perceive the surroundings. However, when the window of LiDAR system is blocked, the LiDAR system can no longer provide effective information for the vehicle computing center. If the vehicle computing center incorrectly uses the information provided by LiDAR in such case, a wrong decision will be made, leading to serious consequences. A vehicle computing center may include one or more vehicle onboard computers or computational resources located elsewhere (e.g., in a cloud server). The vehicle computing center can implement one or more functions such as sensor fusion, object classification, road detection, obstacle prediction, etc., based on the point cloud data provided by the LiDAR system.

In some embodiments, a method of performing window blockage detection for a Light Detection and Ranging (LiDAR) system is provided. The method includes generating one or more beams of light using a laser source within the LiDAR system. For example, the LiDAR system includes a laser source that generates the light beam. In another step, the method may include transmitting, using the optical component, the beam of light through a window. For example, the LiDAR system may include an optical steering mechanism that couples to receive the beam of light. The LiDAR system may include a window positioned adjacent to a recess within the housing of the LiDAR system, where the optical steering mechanism steers the light beam through the window. After the light beam hits an object and is reflected back towards the window of the LiDAR system, the method may include receiving both scattered light and a return light pulse. For example, a window blockage detector can couple to receive the return light pulse from the object in the path of a beam of light. The window blockage detector can also couple to receive the light that is scattered from the light beam hitting the window. The method may further include determining a window state that identifies whether the window is blocked or not, based upon the received scattered and return light pulse. Moreover, the method may include generating, based upon the detected window state, a notification and sending the notification to a vehicle perception and planning system of a vehicle.

In an effort to improve the robustness of window blockage detection, the method for determining the window state includes a process that addresses the partially blocked windows. In particular for some examples, the method for determining the window state may include measuring a first reading of amplitudes and pulse widths of the scattered light and the return light pulse and waiting a predetermined time before taking a second reading. The method of determining the window state may also include detecting whether a first ratio relative to the reflected light in proportion to the laser emission of the beam of light is less than a first threshold, using both the first reading and the second reading. In response to a detected first ratio equal to or greater than the first threshold, the window state is identified to be unblocked. In response to detected first ratio less than the first threshold, the method includes determining whether a second ratio relative to the scattered light in proportion to the laser emission of the beam of light is greater than a second threshold, using both the first reading and the second reading. In response to a detected second ratio greater than the second threshold, the method may include identifying the window state to be blocked. In the alternative, in response to a detected second ratio equal and less than the second threshold, the method may include identifying the window state to be null, wherein null exists when the beam of light intersects an empty sky or a highly absorbent object.

In some embodiments, a LiDAR system, having window blockage detection capabilities, aids in the vehicle safety and reliability of a vehicle perception system. The LiDAR system comprises a laser source for generating a beam of light. The laser source couples to an optical device having a window blockage detector and an optical transceiver. In some examples, the optical transceiver may comprise an optical receiver and an optical transmitter. In some examples, the LiDAR system includes a housing having a recess; wherein, a window couples to the housing adjacent to the recess. In some examples, the window is seated within the recess of the housing. The optical transceiver couples to receive and transmit the beam of light through the window. After the light beam is sent, the optical transceiver couples to receive scattered light from the window, as well as returning light from an object in the path of a beam of light. The window blockage detector couples to the optical transceiver to detect a window state relative to whether the window is blocked. In some examples, the window state can be selected one of the following states including, unblocked, blocked, and null; wherein the null state exists when the beam of light intersects an empty sky or a highly absorbent object. A highly absorbent object absorbs nearly all light and reflects a small or negligible amount of light. As a result, limited by its sensitivity floor, the LiDAR system cannot detect, or detects a negligible amount of, reflected light, if any, from an highly absorbent object. The LiDAR system further comprises an control circuitry for sending a representation of the window blocking state to a vehicle perception and planning system for guided driver automation based upon the detected one of three window states.

Advantageously, a LiDAR system having the window blockage detection capabilities is of great significance to the vehicle safety and to the reliability of a vehicle perception system. Specifically, when window blockage data notifications are sent to a vehicle perception and planning system, the reliability of the LiDAR system is greatly enhanced. This same data can be sent to other vehicles to benefit the safety of others. Furthermore, the window blockage data can be sent to an intelligent infrastructure system to improve various artificial intelligence processes associated with driving.

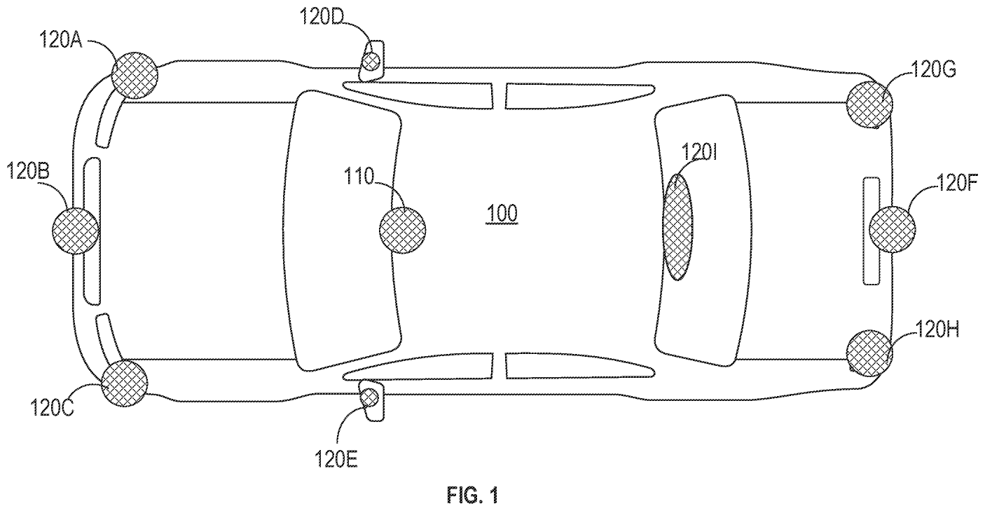

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, a unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver's intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over control of the vehicle when necessary. A fully automated vehicle can perform all vehicle operations without a driver's intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning-based LiDAR system transmits laser light to illuminate an FOV without scanning. For example, a flash LiDAR is a type of non-scanning-based LiDAR system. A flash LiDAR can transmit laser light to simultaneously illuminate an FOV using a single light pulse or light shot.

A LiDAR system is a frequently used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

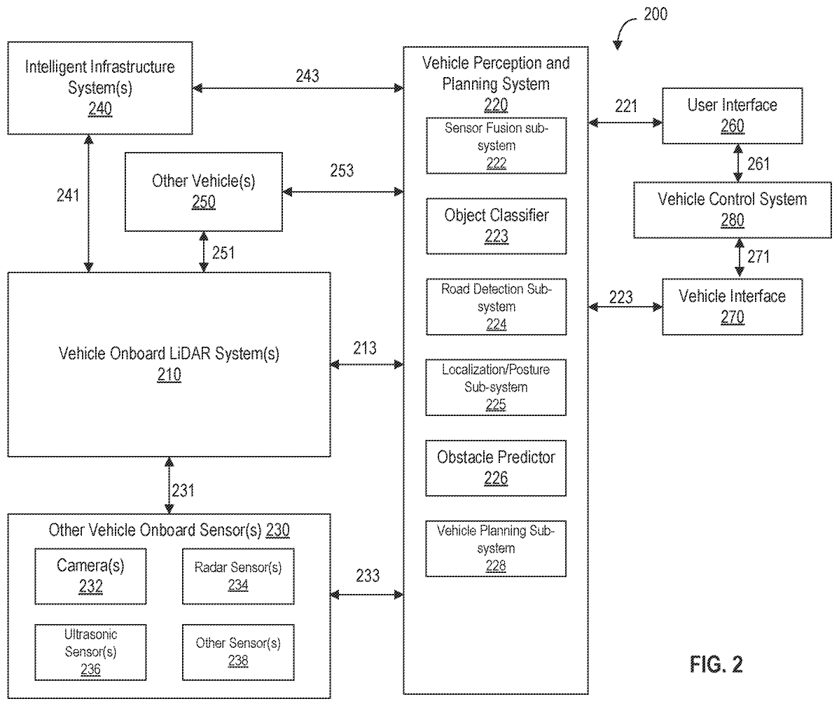

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle's control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mount on, or integrated to, a vehicle at any locations (e.g., rear-view mirrors, pillars, front grille, and/or back bumpers, etc.).

Other vehicle onboard sensos(s) 230 can also include radar sensor(s) 234. Radar sensor(s) 234 use radio waves to determine the range, angle, and velocity of objects. Radar sensor(s) 234 produces electromagnetic waves in the radio or microwave spectrum. The electromagnetic waves reflect off an object and some of the reflected waves return to the radar sensor, thereby providing information about the object's position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, and the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mount on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any locations (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle's headlight during nighttime) directly. A LiDAR system 210 may not be affected as much and therefore sensor fusion sub-system 222 can combine sensor data provided by both camera 232 and LiDAR system 210 and use the sensor data provided by LiDAR system 210 to compensate the unclear image captured by camera 232. As another example, in rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle's posture. For example, using sensor data from LiDAR system(s) 210, camera(s) 232, and/or GPS data, localization and vehicle posture sub-system 225 can determine an accurate position of the vehicle on the road and the vehicle's six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle's location. For instance, using the HD maps, localization and vehicle posture sub-system 225 can determine precisely the vehicle's current position (e.g., which lane of the road the vehicle is currently in, how close it is to a curb or a sidewalk) and predict vehicle's future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle's trajectory intersects with the vehicle's current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network-based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle's current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. Communication can be performed through communication paths 223 and 271, which include any wired or wireless communication links that can transfer data.

Vehicle control system 280 controls the vehicle's steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle's location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

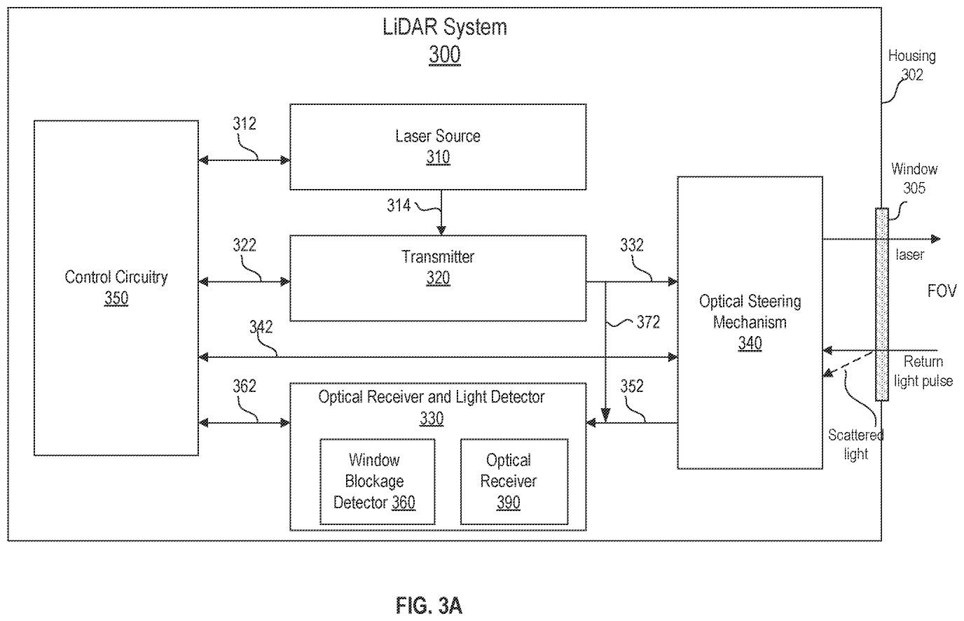

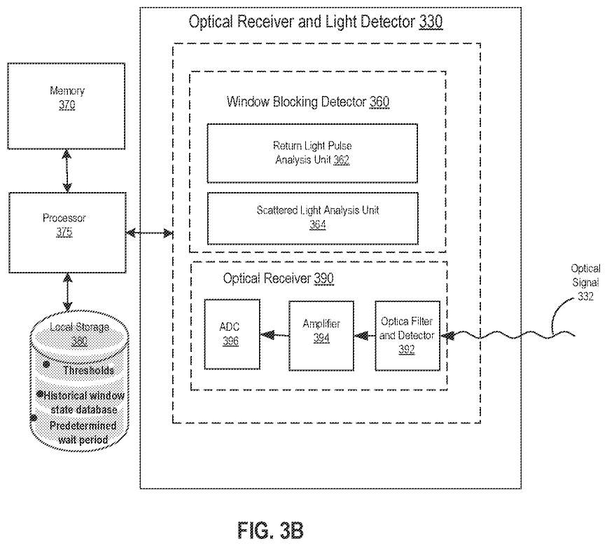

Referring now to FIG. 3A, a block diagram illustrating an example LiDAR system 300 is shown. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, an optical steering mechanism 340, and a control circuitry 350. In some embodiments, optical receiver and light detector 330 includes a window blockage detector 360 and an optical receiver 390. In some embodiments, at least a part of the window blockage detector 360 may be included in control circuitry 350. A window 305 is positioned adjacent to a recess within the housing 302 of LiDAR system 300. Housing 302, in some examples, has the recess defining a path within the FOV through which optical signals from the light source 310/transmitter 320 and returning from an object in the FOV may pass in and out of the system 300. Each of the components (310, 320, 330, 340, and 350) are coupled together using communications paths 312, 314, 322, 332, 342, 352, and 362, respectively. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component or include one or more optical fibers and one or more electrical wires).

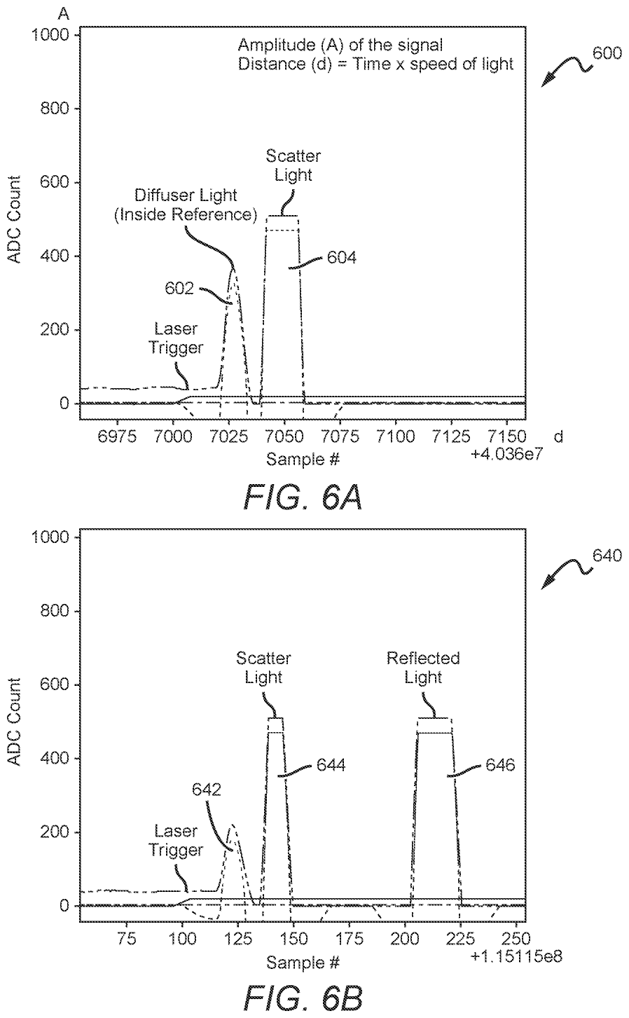

Referring now to FIG. 3B, a block diagram of an optical receiver and light detector 330 of the example LiDAR system 300 of FIG. 3A is illustrated. The window blockage detector 360 comprises a return light pulse analysis unit 362 and a scattered light analysis unit 364. The optical receiver 390 comprises an optical filter and detector 392, an amplifier 394, and an analog-to-digital converter (ADC) 396. The optical filter and detector 392 is to receive optical signals 332, which may include a return light pulse or scattered light. Optical filter and detector 392 can include a detector (e.g., an avalanche photodetector or APD) that converts the optical signals 332 to electrical signals (e.g., electrical current signals). Optical filter and detector 392 can further filters out noise (e.g., background noise) and/or light that have wavelengths outside of the wavelengths used for operating the LiDAR system 300. The filtered optical signal is amplified by the amplifier 394, which can be, for example, a transimpedance amplifier (TIA) that converts an electrical current signal to an electrical voltage signal). The results of the amplifier 394 are analog signals (e.g., analog voltage signals). The analog signals can be sampled and converted to digital signals by ADC 396. Examples of the digital signals provided by ADC 396 are shown in FIGS. 6A-6B below. The digital signals from ADC 396 are sent to the window blockage detector 360 to determine whether the window is in one of three window states including, unblocked, blocked, and null, wherein null exists when the beam of light intersects an empty sky or a highly absorbent object. In particular, the return light pulse analysis unit 362 analyzes the existence and amplitude of the return light pulse. The scattered light analysis unit 364 analyzes the existence and amplitude of the scattered light from the window. While FIG. 3B illustrates that the window blockage detector 360 as being included in optical receiver and light detector 330, it is understood that it can be included in other part of LiDAR system 300 such as control circuitry 350.

With references to both FIGS. 3A and 3B, in operation, the laser source 310 generates one or more beams of light for projection within the FOV of the LiDAR system 300, in an effort to detect any object within the FOV. The optical steering mechanism 340 steers the beam in a horizontal and vertical scanning direction. When an object is in the path of the beam of light, a return light pulse will return to the LiDAR system 300. The optical receiver 390 will receive the optical signals reflected back to the system for analysis. The optical steering mechanism 340 couples to receive and transmit the beam of light through the window 305. After the light beam is sent by laser source 310/transmitter 320, the optical receiver and light detector 330 couples to receive scattered light from the window 305, as well as a return light pulse from an object located in the path of the beam of light. The window blockage detector 360 couples to the optical receiver 390 to receive digital electrical signals provided by ADC 396. Based on such digital electrical signals, window blockage detector 360 can detect a window state relative to whether the window is blocked. In some examples, the window state can be selected from one of the following states including, unblocked, blocked, and null; wherein the null state exists when the beam of light intersects an empty sky or a highly absorbent object. The LiDAR system 300 further comprises the control circuitry 350, which includes a processor 375, a memory device 370, and a local storage 380. Control circuitry 350 can be configured to communicate with window blockage detector 360 and send the results of window blockage detector 360 (e.g., a representation of the window state detected) to a vehicle perception and planning system 220, as shown in FIG. 2 for guided driver automation based upon the detected one of three window states. In some embodiments, the results of the window blocking state detection can be sent to the intelligent infrastructure system 240 and/or another vehicle 250. As shown in FIG. 3B, in one example, local storage 380 can store data including threshold values, a window state database, and predetermined wait period. This data are described in greater details below.

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3A, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object's range as well as its relative velocity along the line-of-sight (LOS).

LiDAR system 300 can also include other components not depicted in FIG. 3A, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high-power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high-power gain such that the laser output can have high power, thereby enabling the LiDAR system to have a long scanning range. In some examples, the power amplifier of light source 310 can be controlled such that the power gain can be varied to achieve any desired laser output power.

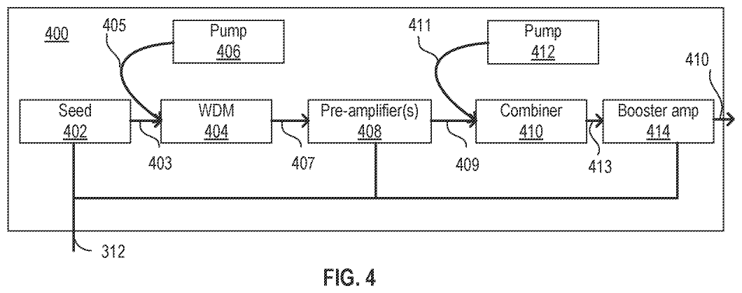

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3A. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The output light pulses can then be transmitted to transmitter 320 and/or steering mechanism 340 (shown in FIG. 3A). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3A) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing back to FIG. 3A, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3A, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3A illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3A further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector's capability of maintaining linear relationship between input optical signal power and the detector's output. A detector having good linearity can maintain a linear relationship over a large dynamic input optical signal range.

To achieve desired detector characteristics, configurations or customizations can be made to the light detector's structure and/or the detector's material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector's internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3A further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3A, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and/or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIGS. 3A and 3B and the above descriptions are for illustrative purposes only, and a LiDAR system can include other functional units, blocks, or segments, and can include variations or combinations of these above functional units, blocks, or segments. For example, LiDAR system 300 can also include other components not depicted in FIGS. 3A and 3B, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3A are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

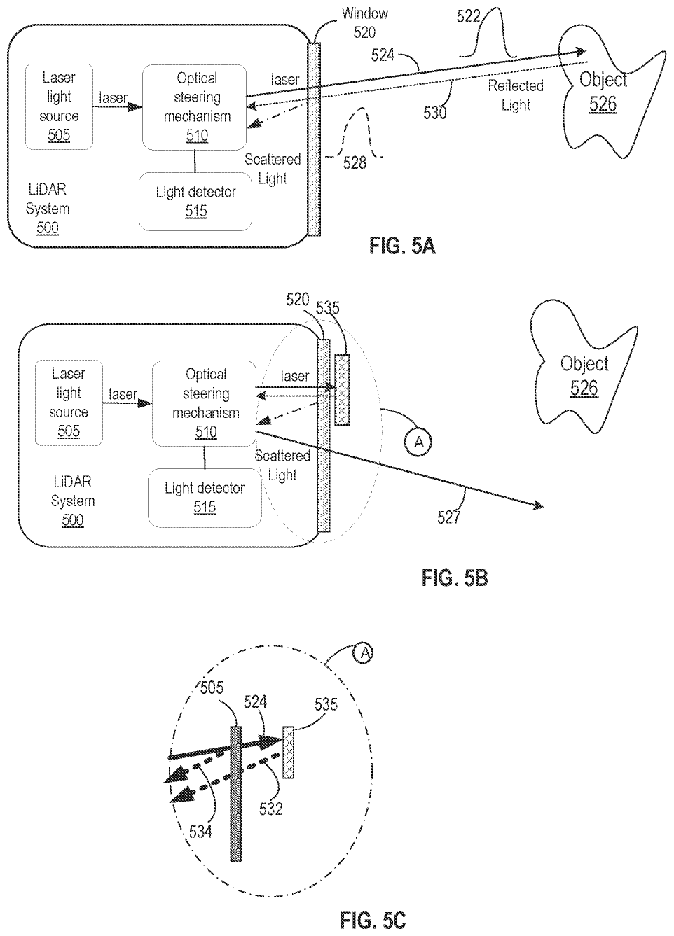

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser) 505, a steering mechanism 510 (e.g., a system of one or more moving mirrors), and a light detector 515 (e.g., a photodetector with one or more optics). LiDAR system 500 can be implemented using, for example, LiDAR system 300 described above. LiDAR system 500 may also include a transmitter similar to transmitter 320 described above. For simplicity, in FIGS. 5A and 5B, the transmitter is omitted. LiDAR system 500 transmits a light pulse 522 along light path 524 through window 520 as determined by the steering mechanism 510 of LiDAR system 500. In the depicted example, light pulse 522, which is generated by the laser light source 505, is a short pulse of laser light. Further, signal steering mechanism 510 of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A, when no blockage of window 520 exists, light pulse 522 reaches object 526. Upon impact with object 526, light pulse 522 scatters or reflects by a portion of object 526 to form a return light pulse 528. Return light pulse 528 may return to system 500 along light path 530. The time from when transmitted light pulse 522 leaves LiDAR system 500 to when return light pulse 528 returns to LiDAR system 500 can be measured (e.g., by a processor or other electronics, such as control circuitry 350, within the LiDAR system). Detection as to whether the window is blocked or not can occur using the light detector 515 (e.g., by a processor or other electronics, such as the window blockage detector 360 within the LiDAR system). This time-of-flight combined with the knowledge of the speed of light can be used to determine the range/distance from LiDAR system 500 to the portion of object 526 where light pulse 522 scattered or reflected.

Referring now to FIG. 5B, the example LiDAR system 500 of FIG. 5A, wherein the window is partially blocked with an obstructing object is shown. As depicted in FIG. 5A, LiDAR system 500 scans the external environment (e.g., by directing light pulse 522 along light path 524). Yet, when window 520 is partially blocked by an obstructing object 535, the light pulse 522 reaches the obstructing object 535 and returns as a return light pulse. The light pulse 522 cannot reach object 526, due to this blockage. Additionally, light is scattered by window 520 and the scattered light returns to steering mechanism 510. The light detector 515 couples to receive the return light pulse and the scattered light from the window 520 to detect the window state and to generate a notification to various parts of the control circuit (350) and the vehicle perception and planning system (220).

FIG. 5C illustrates the example LiDAR system 500 of FIG. 5B with pulse signals of region A showing a return light pulse from the obstructing object 535 and scattered light from the window 520. Specifically, within region A, a laser light pulse is transmitted along path 524 and reaches obstructing object 535. The light pulse transmitted along path 524 returns as a return light pulse along path 532. Because the obstructing object 535 is located very close to LiDAR system 500, the return light pulse has a high signal strength. Scattered light from window 505 returns towards the optical steering mechanism 510 along path 534. The light detector 515 couples to the steering mechanism to receive the return light pulse along path 532 and the scattered light from the window 520 along path 534. While the above description of FIGS. 5B and 5C uses a partially blocked window as an illustration, it is understood the window 520 of system 500 may be completed blocked. Return light pulse from an obstructing object completely blocking the window 520 and scattered light can also be directed to light detector 515 for further processing.

As depicted in FIG. 5A, based on the direction of the transmitted light pulse 522 (as determined by LiDAR system 500) as well as the calculated range from LiDAR system 500 to the portion of objects that scatter or reflect the light pulses (e.g., the portions of object 526), the external environment within the detectable range (e.g., the field of view along path 530) can be precisely mapped or plotted (e.g., by generating a 3D point cloud or images). However, when an obstructing object 535 is present, a window blockage detector (e.g., detector 360 shown in FIG. 3) can be used to generates a window state. The window blockage detector may be included as a part of light detector 515 and/or control circuitry of LiDAR system 500. A “blocked” window state can be used as a trigger for an alert notification to the user to clean the window of the LiDAR system 500. The “blocked” window state can also be used as a trigger for an alert notification to be sent to the vehicle perception and planning system (220), such that a decision will not be made based upon missed object detection. The “blocked” window state can also be used as a signal trigger sent to the control circuitry (350) for further processing and adjustment of controls sent to the laser source (310), transmitter (320) and optical steering mechanism (340). For example, when a window is blocked, the control circuitry can instruct the laser source to turn off and control the steering mechanism to stop, thereby saving power and improving safety and reliability when the window is blocked.

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, a light pulse transmitted along path 527 may not have a corresponding return light pulse because the light pulse transmitted along path 527 may not produce a scattering event along its path 527 within the predetermined detection range. LiDAR system 500, or an external system in communication with LiDAR system 500 (e.g., a cloud system or service), can interpret the lack of return light pulse as no object being disposed along light path 527 within the detectable range of LiDAR system 500.

Although not shown in FIGS. 5A-5C, a plurality of light pulses can be transmitted in any order, serially, in parallel, or based on other timings with respect to each other. Additionally, while FIG. 5A depicts a transmitted light pulse in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5A, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals. To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

FIGS. 6A and 6B illustrate graphs 600 and 640 of the results of the Analog-to-Digital Converter (ADC) configured to generate digital signals representing light received by a LiDAR system (e.g., system 300, 500) with respect to a blocked window condition and a non-blocked window condition. FIGS. 6A and 6B each show ADC signals for one firing cycle. A firing cycle starts from laser trigger time point when a light pulse is emitted from the LiDAR system to the next laser trigger time point when a next light pulse is emitted. When a LiDAR system performs scanning, it generates data for many firing cycles. For example, when a LiDAR system completes on full scan of the FOV, it can generate data for a frame. A frame corresponds to many firing cycles (e.g., 10,000 firing cycles).

The horizontal axis of the graphs 600 and 640 shown in FIGS. 6A and 6B represents the sample numbers of the ADC, which corresponds to the time points when ADC performs the sampling of its input analog signals. Based on the time points and the pulse positions, distances from the LiDAR system to an object in the FOV can be calculated. The vertical axis of the graphs 600 and 640 shown in FIGS. 6A and 6B represents the ADC count, which corresponds the amplitude representing the signal intensities of the ADC's input analog signals. As described above, an ADC converts analog signals to digital signals. For example, the ADC receives analog voltage signals representing the received light signals (including the return light pulse formed by objects in the FOV or an obstructing object, and scattered light formed by the window). The signal intensities of the ADC signals thus represent the pulse amplitudes of the received light pulses. The ADC samples the analog voltage signals at a predetermined sampling rate, and quantizes the amplitude of the analog signals to a certain number of bits to obtain the digital signals. Thus, the digital signals provided by the ADC approximate the original input analog signals. The more bits an ADC has, the more accurately it can represent the original analog voltage signal.

Specifically, FIG. 6A illustrates a graph 600 of the results of the ADC configured to generate digital signals representing light received by the LiDAR system 500 shown in FIG. 5B. Graph 600 in FIG. 6A shows the signals received by the LiDAR system 500 where a window is at least partially blocked. FIG. 6A illustrates two signals (each representing a pulse or a pulse group) 602 and 604. Signal 602 is an ADC output signal representing a received light pulse formed by diffuser light, which is an internal light reference pulse. The light reference pulse and a return light pulse can be used for calculation of distances based on the speed of light. Signal 604 is an ADC output signal representing a received light pulse formed by scattered light from a window (e.g., window 520). As described above, FIG. 6A illustrates signals in one firing cycle. Thus, in this particular firing cycle, there is a signal representing a scattered light pulse, but no signals for a reflected light pulse from an object disposed in the FOV of the LiDAR system.

FIG. 6B illustrates a graph 640 of the results of the ADC configured to generated digital signals representing light received by the LiDAR system 500 shown in FIG. 5A. Graph 640 in FIG. 6B shows the signals received by the LiDAR system 500 where at least a part of the window may not blocked. Compared to FIG. 6A, FIG. 6B illustrates three signals (each representing a pulse or a pulse group) 642, 644, and 646. Similar to signal 602, signal 642 is an ADC output signal representing a received light pulse formed by diffuser light, which is an internal light reference pulse. Similar to signal 604, signal 644 is an ADC output signal representing a received light pulse formed by a scattered light pulse from a window (e.g., window 520). Signal 646 is an ADC output signal representing a received light signal formed by a reflective light pulse from an object in the FOV of the LiDAR system. Compared to signal 646, signal 644 is typically located (time-wise shown by the horizontal axis) closer to the laser trigger position. This is because the scattered light pulse is formed from the window of the LiDAR system, which is typically located much closer than the object in the FOV of the LiDAR system. Thus, as shown in FIG. 6B, when at least a part of the window is not blocked, the laser light can go through the window normally and the LiDAR system can receive both a scattered light pulse (formed from the window) and a reflected light pulse (formed from the object in FOV). FIG. 6B also illustrates signals in one firing cycle. Thus, in this particular firing cycle, there is a signal representing a scattered light pulse and a signal representing a reflected light pulse from an object disposed in the FOV of the LiDAR system.

In some embodiments, determining whether a scatter light pulse or a reflected light pulse exists in a particular firing cycle can be based on the ADC signal intensity representing the pulse amplitude and/or the ADC signal positions along the horizontal axis. For instance, based on the data shown in FIG. 6B, if a particular signal (e.g., signal 644) is located close to the position of a laser trigger 642 (e.g., less than certain position threshold) and the signal has an intensity that is greater than an intensity threshold, the signal can be determined to represent a scatter light pulse. In another example, if a particular signal (e.g., signal 646) is located at a certain distance from the laser trigger that is greater than the position threshold (and/or if there is already detected another scatter light pulse) and the signal has an intensity that is greater than an intensity threshold, the signal can be determined to represent a reflected light pulse.

In some embodiments, as shown in FIG. 6A, when at least a part of the window is blocked, the laser light emitted by the LiDAR system is scattered by the obstructing objects blocking the window. As a result, the scattered light formed by the obstructing objects blocking the window merges with the scattered light formed by the window (because the obstructing objects are typically located very close to the window). For a blocked window, no light is reflected back from an object and therefore no ADC output signal is present for a reflected light pulse from the object in the FOV, as shown in FIG. 6A. In contrast, FIG. 6B shows that there is an ADC output signal 646 representing the reflected light pulse from the object in the FOV, indicating that the window is not blocked. Moreover, the signal widths of the ADC signals representing the scattered light may be different when the window is blocked from when the window is unblocked. FIG. 6A shows that, when the window is at least partially blocked, the ADC output signal 604 representing the scattered light has a wider band of samples. This is because signal 604 represents the merged signals of the scattered light from the window and the scattered light from the obstructing object blocking the window. Thus, when the window is blocked, the scattered signal has a wider signal width. In contrast, when the window is unblocked, ADC signal 644 representing the scattered light covers a narrower band of samples (in FIG. 6B). This is because signal 644 only represents the signal of the scattered light from the window, and thus the signal width is narrower compared to signal 604. In other embodiments, when the window is blocked (and therefore the scattered light of the window merges with the scattered light of the obstructing object), the signal amplitude of the merged signal can be higher than the signal amplitude of only the scattered light of the window. The amplitude difference is not shown in FIGS. 6A and 6B, in which signals 604 and 644 have flat top, indicating that the ADC has saturated because the amplitudes of signals 604 and 644 have already exceeded the dynamic range of the ADC. Instead, the signal amplitude difference between signals 604 and 644 is reflected by the different pulse widths between the two signals.

In some embodiments, the method of window blockage detection includes a thresholding analysis for enhanced reliability of detection of a partial blockage. The method can be performed by the window blockage detector and/or the control circuitry. As described above, each of FIGS. 6A and 6B shows signals in one firing cycle. The window blockage detection can be performed for many firing cycles representing a full scanning range of the LiDAR system. A full scanning by the LiDAR system may provide a frame of the point cloud data generated by the LiDAR system. Thus, if the multiple firing cycles (e.g., 10,000 firing cycles) corresponding to a frame are analyzed, the detection of the window blockage can be more accurate. In one example, for each of the multiple firing cycles, the window blockage detector determines if there is a reflected light pulse and if there is a scattered light pulse. As described above, the determination of the if a reflected or scattered light pulse exists in a particular firing cycle can be based on the laser trigger position, the pulse positions, and signal intensity thresholds for a scattered pulse and for a reflected pulse. For all the firing cycles corresponding to, for example, a frame of data, the number of firing cycles that have reflected light pulses and the number of firing cycles that have scattered light pulses can be counted.

Next, a first ratio is calculated. The first ratio is a ratio of the number of firing cycles that have reflected light pulses with respect to a total number of firing cycles. If the first ratio is greater than or equal to a first threshold, it indicates that sufficient lasers can be emitted out of the window. Thus, the window is considered not blocked. For instance, if, for a frame corresponding to 10,000 firing cycles, the number of firing cycles that have reflected light pulses is 9,000, then the first ratio is 90%. The first threshold may be configured to be, for example, 60%, 65%, 70%, 75%, 80%, 85%, etc. Therefore, in this case, the first ratio of 90% is greater than the first threshold. Thus, it indicates that sufficient amount of light was transmitted out of the window to the FOV, which caused the high amount of reflected light pulses. As a result, the window state can be identified as unblocked.

If the first ratio is less than the first threshold, it means that the LiDAR system has received little or no reflected light (e.g., received only noise background). In some cases, this could be due to the emitted light beam being aimed at an empty sky or highly absorbent objects. In other instances, minimal reflected light can mean that the window is blocked. A second ratio based on the scattered light pulses can be taken into consideration when determining whether a window is blocked or whether the emitted light beam is being aimed at an empty sky or highly absorbent objects. The second ratio is calculated by using the number of firing cycles that have scattered light pulses but no reflected light pulses and the total number of firing cycles. When the second ratio is greater than or equal to a second threshold, the window is considered as blocked. For instance, the number of firing cycles that have scattered light pulses but no reflected light pulses may be 9,900, and the total number of firing cycles may be 10,000. Thus, the second ratio is 99%. The second threshold may be configured to be, for example, 80%, 85%, 90%, 95%, etc. As described above, if a window is blocked by an obstructing object, the scattered light from the window and from the obstructing object merges. As a result, when the window is blocked, the signal for the scattered light pulse is strong and there may not be any detectable reflected pulses. Thus, in the above example, the second ratio is greater than the second threshold, indicating that the window is blocked.

In some examples, if the first ratio is less than the first threshold and the second ratio is less than the second threshold, it means that out of the total number of firing cycles, (1) the number of firing cycles that have reflected light pulses does not meet the first threshold; and (2) the number of firing cycles that have scattered light pulses but no reflected light pulses does not meet the second threshold. In this case, the window blockage state can be classified as null. A null state exists when the light beams originated from the light source may be transmitted toward an empty sky, a high absorbent object, or does not hit any object within a detection range.

To improve the robustness of window blockage detection, a type of hysteresis logic and delay judgment can be implemented in the window detection process to account for the window blockage state transition. Particularly, as described above, the first threshold is compared to the first ratio; and the second threshold is compare to the second ratio. Thus, in some embodiments, the transition from a blocked window state to a non-blocked window state can be determined based on the first threshold (threshold 1) and a first predetermined time period (delay time 1). For instance, if the current window blockage state has been determined to be blocked. After a delay time 1, the window blockage detector and/or the control circuitry determines that the first ratio (i.e., the ratio of the number of firing cycles that have reflected light pulses with respect to a total number of firing cycles) has transitioned from being less than threshold 1 to greater than or equal to the threshold 1, then it determines that the window blockage state has transitioned from blocked to unblocked. Similarly, if the current window blockage state is unblocked, a transition from the unblocked window state to the blocked window state can be determined based on the second threshold (threshold 2) and a second predetermined time period (delay time 2). For instance, if after delay time 2, the window blockage detector determines that the second ratio (i.e., the ratio of the number of firing cycles that have scattered light pulses but no reflected light pulses to the total number of firing cycles) transitioned from being less than threshold 2 to greater than or equal to the threshold 2, then it determines that the window blockage state has transitioned from unblocked to blocked. Threshold 1 may or may not be equal to threshold 2; and delay time 1 may or may not be equal to delay time 2. One example of the delay time 1 and/or delay time 2 is on the order of seconds. In some embodiments, a window blockage state flag may be set that indicates the window state. Further, the window blockage state flag may be stored in a window state database. Thereby, by using the hysteresis logic and delay judgement, the frequency of state switching can be significantly reduced and the reliability and accuracy of the window blockage detection can be improved.

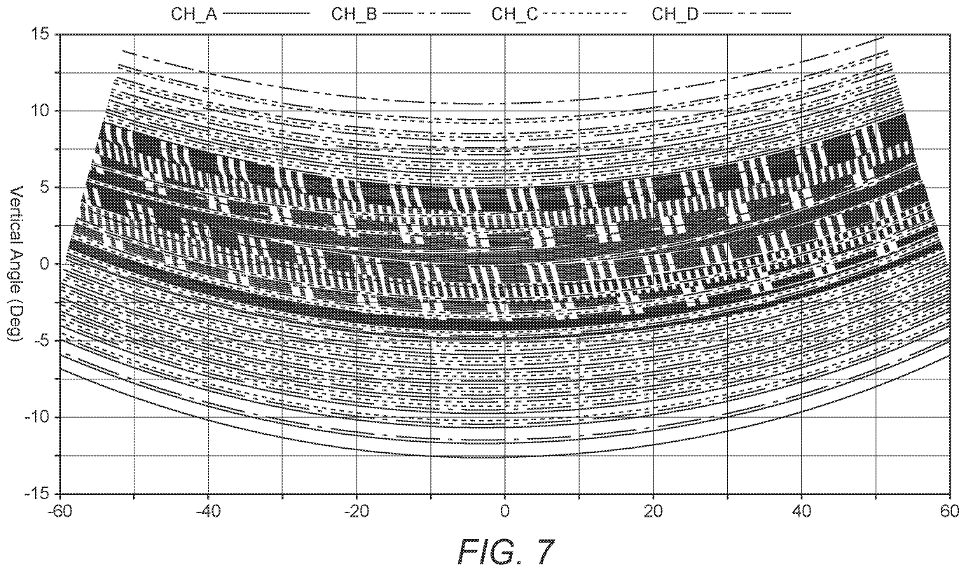

Referring now to FIG. 7, a graphical depiction of the whole FOV divided into meshes of an m by n grid in accordance with the Galvanometer mirror scanning angle limit position and the polygon mirror scanning angle of the LiDAR system shown in FIG. 3A, according to some examples is shown. The methods and systems described above can be adapted to detect window blockage based upon the ratios of the reflected light, the scattered light, and the emitted light in the FOV. To account for partial blockage, the above-described method can be used for a grid having multiple segments. Each of the segments covers a sub-FOV region. For instance, the window blockage detector and/or control circuitry may divide the FOV into an m*n grid, as shown in FIG. 7, wherein m and n are integer numbers. In the example shown in FIG. 7, the FOV may correspond to a horizontal scanning range of −60° to 60°; and a vertical scanning range of −15° to 15°. One segment of the grid shown in FIG. 7 thus approximately correspond to 10° horizontally and 2.5° vertically. It is understood that any other values for the ranges or segments may also be possible. According to the scanning angle of the Galvanometer mirror and the polygon mirror, the FOV is divided into meshes. In some embodiments, the above-described method of window block detection can be applied to each segment of the grid. Thus, for each segment, the number of firing cycles that have reflected light pulses and the number of firing cycles that have scattered light pulses but no reflected light pulses can be determined. For each segment, a first ratio of the number of firing cycles that have reflected light pulses with respect to the total number of firing cycles associated with the particular segment can be calculated. Likewise, a second ratio of the number of firing cycles that have scattered light pulses but no reflected light pulses with respect to the total number of firing cycles associated with the particular segment can also be calculated. Determination of a blockage state flag of each segment of the grid can be performed using the above-described method. The blockage state flag of each grid can indicate, for example, whether a portion of the window corresponding to the particular segment of the grid is blocked or unblocked. In other words, each segment of the grid has its own blockage state flag. The calculation of the blockage state flag can use the above-described methods, but applied at the segment level.

In some embodiments, there are two directions of the Galvanometer mirror motion for the LiDAR to scan a vertical direction of the FOV (e.g., vertically from bottom to up and from up to bottom). As a result, the window blockage state can be updated every two frames in order to reduce the influence of Galvanometer mirror motion asymmetry and to reduce the computational workload of a processor. In some embodiments, the blockage state of the window can be determined by the window blockage detector and/or the control circuitry according to the following steps. In a first step, the blockage state flag of each segment of the grid (shown in FIG. 7) is calculated using the window state detection method described supra, applied at the segment level. When the number of segments that have a blocked state flag is more than threshold C in a k*k grid matrix (k is an integer), the window is considered to be blocked. It is understood that the threshold C can be set for a k*l grid matrix where k and 1 are different integer numbers. If in the first step, the number of segments that have a blocked state flag is sufficiently large (e.g., greater than threshold C), the window can be treated as blocked and the second step described below may not need to be performed. In some examples, the location and the blockage state information associated with each segment of the grid is sent to the control circuitry (e.g., circuitry 350) for further processing. The location and blockage state information for all segment can collectively indicate where a partial blockage might have occurred.

If the number of segments that have a blocked state flag does not satisfy the threshold C, a second step is performed. In the second step, the above-described method for detecting whether there is blockage for the entire FOV is performed. That is, with respect to all received reflected light pulses and scattered light pulses in the entire FOV, the first ratios (the number of firing cycles having reflected light pulses divided by the total number of firing cycles) and the second ratio (a ratio of the number of firing cycles that have scattered light pulses but no reflected light pulses divided by the total number of firing cycles) are calculated without dividing the FOV into a grid. Based on the first ratio and second ratio, the windows blockage state can be determined using the first threshold and the second threshold, respectively, as described above. And the determined window blockage state can be sent to the control circuitry for further processing or for further control of the LiDAR system. The above two-step window blockage detection method can be performed to detect partial window blockage and the locations of the partial window blockage, thereby improving the accuracy of the detection.

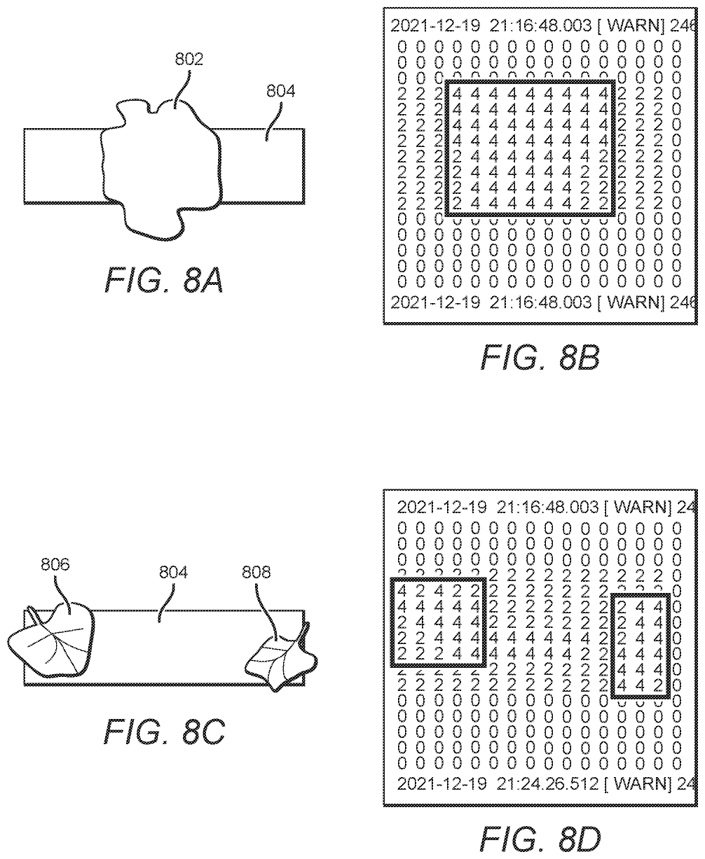

FIG. 8A illustrates a first example of a partially blocked window 804 of a LiDAR system, according to some examples. FIG. 8B illustrates an associated representative grid of an FOV scanned by the LiDAR system having the partially blocked window 804 shown in FIG. 8A. In FIG. 8B, the segments of the gird having blockage state flag values that reach a value greater than a blockage threshold value are distinguished using a higher digital value. In FIG. 8B, larger values are present in the middle of the grid, indicating that the obstructing object is present in the middle of the window. In particular for this example, the blockage state flag value of a “4” represents a portion of the window for the particular grid segment that is completely blocked; the value of “2” represents a grid segment that is partially blocked; and the value of “0” represents a grid segment where no blocking exists.

FIG. 8C illustrates a second example of a partially blocked window 804 of a LiDAR system having two obstructing objects, according to some examples. FIG. 8D illustrates an associated representative grid of the FOV scanned by the LiDAR system having the partially blocked window 804 in FIG. 8C. In FIG. 8D, the segments of the gird having blockage flag values that reach a value greater than a blockage threshold value are distinguished using a higher digital value. In FIG. 8D, larger values are present in two different segments (left and right) of the grid, indicating that each obstructing object is present in on the left and right portions of the window. Similar for this example, the blockage flag value of a “4” represents a grid block that is completely blocked; the value of “2” represents a grid block that is partially blocked; and the value of “0” represents a grid block where no blocking exists.

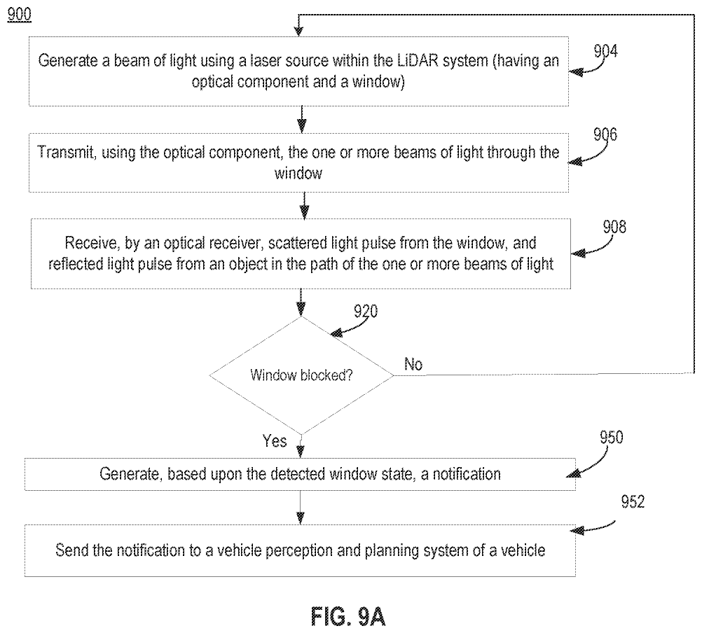

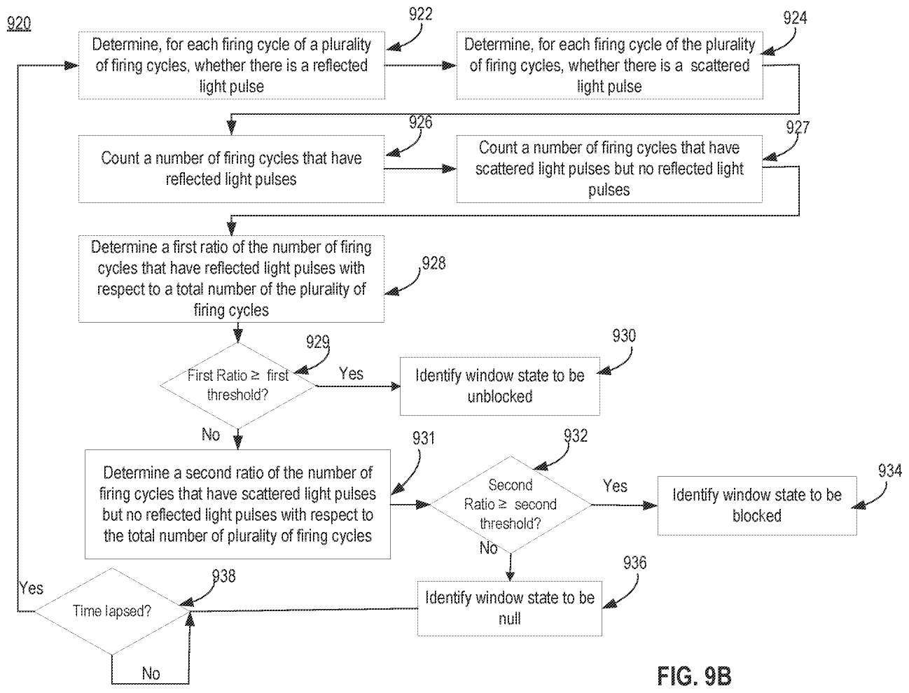

FIG. 9A illustrates a flow diagram of method 900 for detecting the blocked window state of a LiDAR system, having window blockage detection capabilities, of FIGS. 3A-3B in accordance with some embodiments. In step 904, method 900 includes generating a beam of light using a laser source within the LiDAR system. For example, the LiDAR system includes a laser source that generates the light beam. In step 906, the method may include transmitting, using the optical component, the beam of light through a window. For example, the LiDAR system may include an optical steering mechanism that couples to receive and transmit the beam of light. The LiDAR system may include a window set adjacent to a recess of the housing of the LiDAR system, where the optical steering mechanism steers the light beam through the window. After the light beam hits an object and is reflected back towards the window of the LiDAR system, method 900 may include receiving both a scattered light pulse and a reflected light pulse in step 908. For example, an optical receiver can couple to receive the reflected light pulse from the object in the path of a beam of light. The optical receiver can also couple to receive the light that is scattered from the emitted light beam hitting the window. The method 900 may further include determining a window state that identifies whether the window is blocked or not, based upon the received scattered light pulse and received reflected light pulse in step 920. In response to the window not being either fully or partially blocked, the method 900 may loop back to step 904 (or any of the previous steps) to evaluate another light beam transmission and light pulses reception. In response to the window being either fully or partially blocked, method 900 may include generating, based upon the detected window state, a notification in step 950. In step 952, method 900 may include sending the notification to a vehicle perception and planning system of a vehicle.

FIG. 9B shows a flow diagram of method 920 for detecting whether the window is blocked or not (step 920) of the method 900 shown in FIG. 9A in accordance with some embodiments. In step 922, method 920 for determining the window state may include determining, for each firing cycle of a plurality of firing cycles, whether there is a reflected light pulse. In step 924, method 920 may include determining, for each firing cycle of the plurality of firing cycles, whether there is a scattered light pulse. In step 926, the method 900 of determining the window state may also include counting a number of firing cycles that have reflected light pulses. In step 927, method 920 includes counting a number of firing cycles that have scattered light pulses but no reflected light pulses. In step 928, method 920 determines a first ratio of the number of firing cycles that have reflected light pulses with respect to a total number of the plurality of firing cycles. In the decision step 929, method 920 determines whether the first ratio is greater than or equal to a first threshold. In response to a detected first ratio equal to or greater than the first threshold, the window state is identified to be unblocked in step 930.

In response to detected first ratio less than the first threshold, the method 920 includes a step 931 for determining a second ratio of the number of firing cycles that have scattered light pulses but no reflected light pulses with respect to the total number of plurality of firing cycles. In the decision step 932, method 920 determines whether the second ratio is greater than or equal to a second threshold. In response to a detected second ratio greater than or equal to the second threshold, method 920 may include identifying the window state to be blocked in step 934. In the alternative, in response to a detected second ratio less than the second threshold, the method 920 may include identifying the window state to be null in a step 936, wherein null exists when the beam of light intersects an empty sky or a highly absorbent object. In an optional step 938, method 900 includes determining if a predetermined time has lapsed. The predetermined time can be a time period relative to generating one or more frames (e.g., two) of the point cloud data. For example, the window blockage state can be updated every two frames in order to reduce the influence of Galvanometer mirror motion asymmetry and to reduce the computational workload of a processor.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 9A-9B, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

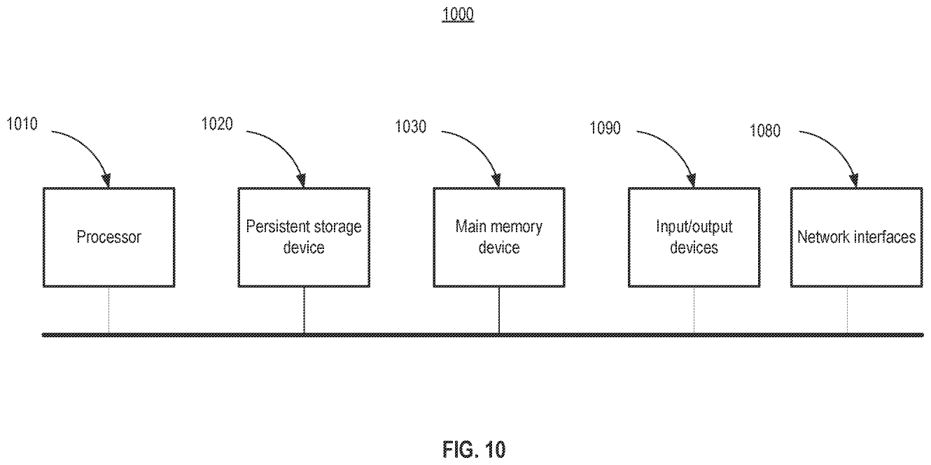

A high-level block diagram of an example apparatus that may be used to implement systems, apparatus and methods described herein is illustrated in FIG. 10. Apparatus 1000 comprises a processor 1010 operatively coupled to a persistent storage device 1020 and a main memory device 1030. Processor 1010 controls the overall operation of apparatus 1000 by executing computer program instructions that define such operations. The computer program instructions may be stored in persistent storage device 1020, or other computer-readable medium, and loaded into main memory device 1030 when execution of the computer program instructions is desired. For example, processor 1010 may be used to implement one or more components and systems described herein, such as control circuitry 350 (shown in FIG. 3A), vehicle perception and planning system 220 (shown in FIG. 2), and vehicle control system 280 (shown in FIG. 2). Thus, the method steps of at least some of FIGS. 9A-9B can be defined by the computer program instructions stored in main memory device 1030 and/or persistent storage device 1020 and controlled by processor 1010 executing the computer program instructions. For example, the computer program instructions can be implemented as computer executable code programmed by one skilled in the art to perform an algorithm defined by the method steps discussed herein in connection with at least some of FIGS. 9A-9B. Accordingly, by executing the computer program instructions, processor 1010 executes an algorithm defined by the method steps of these aforementioned figures. Apparatus 1000 also includes one or more network interfaces 1080 for communicating with other devices via a network. Apparatus 1000 may also include one or more input/output devices 1090 that enable user interaction with apparatus 1000 (e.g., display, keyboard, mouse, speakers, buttons, etc.).

Processor 1010 may include both general and special purpose microprocessors and may be the sole processor or one of multiple processors of apparatus 1000. Processor 1010 may comprise one or more central processing units (CPUs), and one or more graphics processing units (GPUs), which, for example, may work separately from and/or multi-task with one or more CPUs to accelerate processing, e.g., for various image processing applications described herein. Processor 1010, persistent storage device 1020, and/or main memory device 1030 may include, be supplemented by, or incorporated in, one or more application-specific integrated circuits (ASICs) and/or one or more field programmable gate arrays (FPGAs).

Persistent storage device 1020 and main memory device 1030 each comprise a tangible non-transitory computer readable storage medium. Persistent storage device 1020, and main memory device 1030, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1090 may include peripherals, such as a printer, scanner, display screen, etc. For example, input/output devices 1090 may include a display device such as a cathode ray tube (CRT), plasma or liquid crystal display (LCD) monitor for displaying information to a user, a keyboard, and a pointing device such as a mouse or a trackball by which the user can provide input to apparatus 1000.

Any or all of the functions of the systems and apparatuses discussed herein may be performed by processor 1010, and/or incorporated in, an apparatus or a system such as LiDAR system 300. Further, LiDAR system 300 and/or apparatus 1000 may utilize one or more neural networks or other deep-learning techniques performed by processor 1010 or other systems or apparatuses discussed herein.

One skilled in the art will recognize that an implementation of an actual computer or computer system may have other structures and may contain other components as well, and that FIG. 10 is a high-level representation of some of the components of such a computer for illustrative purposes.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method of performing window blockage detection for a Light Detection and Ranging (LiDAR) system, comprising:
generating one or more beams of light using a laser source within the LiDAR system, wherein the LiDAR system having a window and an optical component coupled to receive the one or more beams of light;
transmitting, using the optical component, the one or more beams of light through the window;
receiving, by an optical receiver, scattered light pulses from the window and reflected light pulses from an object in a field-of-view (FOV) of the LiDAR system;
detecting, based upon the received scattered light pulses and received reflected light pulses, a window state indicating whether the window is blocked;
generating, based upon the detected window state, a notification; and
sending the notification to a vehicle perception and planning system of a vehicle.

2. The method of claim 1, wherein the detecting of the window state comprises,
determining, for each firing cycle of a plurality of firing cycles, whether there is a reflected light pulse;
determining, for each firing cycle of the plurality of firing cycles, whether there is a scattered light pulse;
counting a number of firing cycles that have reflected light pulses;
counting a number of firing cycles that have scattered light pulses but no reflected light pulses; and
detecting the window state based on the number of firing cycles that have reflected light pulses and the number of firing cycles that have scattered light pulses.

3. The method of claim 2, wherein the plurality of firing cycles corresponds to a frame of point cloud data provided by the LiDAR system, wherein detecting the window state based on the number of firing cycles that have reflected light pulses and the number of firing cycles that have scattered light pulses comprises:
determining a first ratio of the number of firing cycles that have reflected light pulses with respect to a total number of the plurality of firing cycles;
determining whether the first ratio is greater than or equal to a first threshold; and
identifying, in response to the first ratio equal to or greater than the first threshold, the window state to be unblocked.

4. The method of claim 3, wherein the detecting of the window state further comprises, in response to the first ratio less than the first threshold:
determining a second ratio of the number of firing cycles that have scattered light pulses but no reflected light pulses with respect to the total number of plurality of firing cycles;
determining whether the second ratio is greater than or equal to a second threshold; and
identifying, in response to the second ratio greater than or equal to the second threshold, the window state to be blocked.

5. The method of claim 4, wherein the detecting of the window state further comprises,
in response to the second ratio less than the second threshold, the window state to be null, wherein a null state exists when the one or more beams of light are transmitted toward an empty sky or a highly absorbent object.

6. The method of claim 1, further comprising:
measuring signal widths of the received scattered light, wherein the signal widths of the received scattered light facilitate the detecting of the window state indicating whether the window is blocked.

7. The method of claim 1, further comprises: in response to detecting the window state, setting a window blockage state flag indicating the window state; and
storing the window blockage state flag in a window state database.

8. The method of claim 1, wherein detecting the window state comprises:
dividing the FOV into a grid of segments corresponding to scanning ranges of the LiDAR system in two directions;
determining, for each grid segments, a window blockage state flag indicating whether a portion of the window corresponding to the grid segment is blocked;
detecting the window blockage state based on window blockage state flags associated with a group of grid segments.

9. The method of claim 8, wherein detecting the window blockage state based on window blockage state flags associated with a group of grid segments comprises:
determining a number of the window blockage state flags indicating that window blockage exists;
determining whether the number of the window blockage state flags indicating that window blockage exists is greater than or equal to a threshold number of window blockage flags;
identifying, in response to the number of the window blockage flags indicating window blockage exists greater than or equal to the threshold number of window blockage flags, the window state to be blocked.

10. The method of claim 9, further comprising, in response to the number of the window blockage state flags indicating that window blockage exists less than the threshold number of window blockage flags:
determining, for each firing cycle of a plurality of firing cycles, whether there is a reflected light pulse;
determining, for each firing cycle of the plurality of firing cycles, whether there is a scattered light pulse;
counting a number of firing cycles that have reflected light pulses;
counting a number of firing cycles that have scattered light pulses; and
detecting the window state based on the number of firing cycles that have reflected light pulses and the number of firing cycles that have scattered light pulses, wherein the plurality of firing cycles correspond to a frame of point cloud data provided by the LiDAR system.

11. The method of claim 1, further comprising at least one of,
detecting a transition from a blocked window state to a non-blocked window state, based on a first delay time and a first threshold of a first ratio; and
detecting a transition from a non-blocked window state to a blocked window state, based on a second delay time and a second threshold of a second ratio.

12. A non-transitory computer-readable medium storing instructions in a memory device, the instructions being executable by one or more processors for performing a method of window blockage detection for a Light Detection and Ranging (LiDAR) system, the method comprising:
generating one or more beams of light using a laser source within the LiDAR system, wherein the LiDAR system having a window and an optical component coupled to receive the one or more beams of light;
transmitting, using the optical component, the one or more beams of light through the window;
receiving, by an optical receiver, scattered light pulses from the window and reflected light pulses from an object in a field-of-view (FOV) of the LiDAR system;
detecting, based upon the received scattered light pulses and received reflected light pulses, a window state indicating whether the window is blocked;
generating, based upon the detected window state, a notification; and
sending the notification to a vehicle perception and planning system of a vehicle.

13. The computer-readable medium of claim 12, wherein the detecting of the window state comprises,
determining, for each firing cycle of a plurality of firing cycles, whether there is a reflected light pulse;
determining, for each firing cycle of the plurality of firing cycles, whether there is a scattered light pulse;
counting a number of firing cycles that have reflected light pulses;
counting a number of firing cycles that have scattered light pulses but no reflected light pulses; and
detecting the window state based on the number of firing cycles that have reflected light pulses and the number of firing cycles that have scattered light pulses.

14. The computer-readable medium of claim 13, wherein the plurality of firing cycles corresponds to a frame of point cloud data provided by the LiDAR system, wherein detecting the window state based on the number of firing cycles that have reflected light pulses and the number of firing cycles that have scattered light pulses comprises:
determining a first ratio of the number of firing cycles that have reflected light pulses with respect to a total number of the plurality of firing cycles;
determining whether the first ratio is greater than or equal to a first threshold; and
identifying, in response to the first ratio equal to or greater than the first threshold, the window state to be unblocked.

15. The computer-readable medium of claim 14, wherein the detecting of the window state further comprises, in response to the first ratio less than the first threshold:
determining a second ratio of the number of firing cycles that have scattered light pulses but no reflected light pulses with respect to the total number of plurality of firing cycles;
determining whether the second ratio is greater than or equal to a second threshold; and
identifying, in response to the second ratio greater than or equal to the second threshold, the window state to be blocked.

16. The computer-readable medium of claim 15, wherein the detecting of the window state further comprises,
in response to the second ratio less than the second threshold, the window state to be null, wherein a null state exists when the one or more beams of light are transmitted toward an empty sky or a highly absorbent object.

17. The computer-readable medium of claim 12, further comprising:
measuring signal widths of the received scattered light, wherein the signal widths of the received scattered light facilitate the detecting of the window state indicating whether the window is blocked.

18. The computer-readable medium of claim 12, further comprises: in response to detecting the window state,
setting a window blockage state flag indicating the window state; and
storing the window blockage state flag in a window state database.

19. The computer-readable medium of claim 12, wherein detecting the window state comprises:
dividing the FOV into a grid of segments corresponding to scanning ranges of the LiDAR system in two directions;
determining, for each grid segments, a window blockage state flag indicating whether a portion of the window corresponding to the grid segment is blocked;
detecting the window blockage state based on window blockage state flags associated with a group of grid segments.

20. The computer-readable medium of claim 19, wherein detecting the window blockage state based on window blockage state flags associated with a group of grid segments comprises:
determining a number of the window blockage state flags indicating that window blockage exists;
determining whether the number of the window blockage state flags indicating that window blockage exists is greater than or equal to a threshold number of window blockage flags;
identifying, in response to the number of the window blockage flags indicating window blockage exists greater than or equal to the threshold number of window blockage flags, the window state to be blocked.

21. The computer-readable medium of claim 20, further comprising, in response to the number of the window blockage state flags indicating that window blockage exists less than the threshold number of window blockage flags:
determining, for each firing cycle of a plurality of firing cycles, whether there is a reflected light pulse;
determining, for each firing cycle of the plurality of firing cycles, whether there is a scattered light pulse;
counting a number of firing cycles that have reflected light pulses;
counting a number of firing cycles that have scattered light pulses; and
detecting the window state based on the number of firing cycles that have reflected light pulses and the number of firing cycles that have scattered light pulses, wherein the plurality of firing cycles correspond to a frame of point cloud data provided by the LiDAR system.

22. The computer-readable medium of claim 21, further comprising at least one of, detecting a transition from a blocked window state to a non-blocked window state, based on a first delay time and a first threshold of a first ratio; and
detecting a transition from a non-blocked window state to a blocked window state, based on a second delay time and a second threshold of a second ratio.

23. A Light Detection and Ranging (LiDAR) system, comprising:
a laser source configured to generate one or more beams of light within the LiDAR system;
a window and an optical component coupled to receive the one or more beams of light, wherein the optical component is configured to transmit the one or more beams of light through the window;
an optical receiver configured to receive scattered light from the window, and reflected light from an object, if any, in a field-of-view (FOV) of the LiDAR system;
a window blockage detector configured to:
detect, based upon the received scattered light and received reflected light, a window state indicating whether the window is blocked;
generate, based upon the detected window state, a notification; and
send the notification to a vehicle perception and planning system of a vehicle.

24. The LiDAR system of claim 23, wherein the window blockage detector is configured to detect the window state by,
determining, for each firing cycle of a plurality of firing cycles, whether there is a reflected light pulse;
determining, for each firing cycle of the plurality of firing cycles, whether there is a scattered light pulse;
counting a number of firing cycles that have reflected light pulses;
counting a number of firing cycles that have scattered light pulses but no reflected light pulses; and
detecting the window state based on the number of firing cycles that have reflected light pulses and the number of firing cycles that have scattered light pulses.

25. The LiDAR system of claim 24, wherein the plurality of firing cycles corresponds to a frame of point cloud data provided by the LiDAR system, wherein detecting the window state based on the number of firing cycles that have reflected light pulses and the number of firing cycles that have scattered light pulses comprises:
determining a first ratio of the number of firing cycles that have reflected light pulses with respect to a total number of the plurality of firing cycles;
determining whether the first ratio is greater than or equal to a first threshold; and
identifying, in response to the first ratio equal to or greater than the first threshold, the window state to be unblocked.

26. The LiDAR system of claim 25, wherein the detecting of the window state further comprises, in response to the first ratio less than the first threshold:
determining a second ratio of the number of firing cycles that have scattered light pulses but no reflected light pulses with respect to the total number of plurality of firing cycles;
determining whether the second ratio is greater than or equal to a second threshold; and
identifying, in response to the second ratio greater than or equal to the second threshold, the window state to be blocked.

27. The LiDAR system of claim 26, wherein the detecting of the window state further comprises,
in response to the second ratio less than the second threshold, the window state to be null, wherein a null state exists when the one or more beams of light are transmitted toward an empty sky or a highly absorbent object.

28. The LiDAR system of claim 23, wherein the window blockage detector is further configured to measure signal widths of the received scattered light, wherein the signal widths of the received scattered light facilitate the detecting of the window state indicating whether the window is blocked.

29. The LiDAR system of claim 23, wherein the window blockage detector is further configured to: in response to detecting the window state,
setting a window blockage state flag indicating the window state; and
storing the window blockage state flag in a window state database.

30. The LiDAR system of claim 23, wherein the window blockage detector is further configured to:
divide the FOV into a grid of segments corresponding to scanning ranges of the LiDAR system in two directions;
determine, for each grid segments, a window blockage state flag indicating whether a portion of the window corresponding to the grid segment is blocked;
detect the window blockage state based on window blockage state flags associated with a group of grid segments.

31. The LiDAR system of claim 30, wherein detecting the window blockage state based on window blockage state flags associated with a group of grid segments comprises:
determining a number of the window blockage state flags indicating that window blockage exists;
determining whether the number of the window blockage state flags indicating that window blockage exists is greater than or equal to a threshold number of window blockage flags;
identifying, in response to the number of the window blockage flags indicating window blockage exists greater than or equal to the threshold number of window blockage flags, the window state to be blocked.

32. The LiDAR system of claim 31, further comprising, in response to the number of the window blockage state flags indicating that window blockage exists less than the threshold number of window blockage flags:
determining, for each firing cycle of a plurality of firing cycles, whether there is a reflected light pulse;
determining, for each firing cycle of the plurality of firing cycles, whether there is a scattered light pulse;
counting a number of firing cycles that have reflected light pulses;
counting a number of firing cycles that have scattered light pulses; and
detecting the window state based on the number of firing cycles that have reflected light pulses and the number of firing cycles that have scattered light pulses, wherein the plurality of firing cycles correspond to a frame of point cloud data provided by the LiDAR system.

33. The LiDAR system of claim 23, wherein the window blockage detector is further configured to perform at least one of,
detecting a transition from a blocked window state to a non-blocked window state, based on a first delay time and a first threshold of a first ratio; and
detecting a transition from a non-blocked window state to a blocked window state, based on a second delay time and a second threshold of a second ratio.

34. A vehicle comprising a LiDAR system, the LiDAR system comprises:
a laser source configured to generate one or more beams of light within the LiDAR system;
a window and an optical component coupled to receive the one or more beams of light, wherein the optical component is configured to transmit the one or more beams of light through the window;
an optical receiver configured to receive scattered light from the window, and reflected light from an object, if any, in a field-of-view (FOV) of the LiDAR system;
a window blockage detector configured to:
detect, based upon the received scattered light and received reflected light, a window state indicating whether the window is blocked;
generate, based upon the detected window state, a notification; and
send the notification to a vehicle perception and planning system of a vehicle.
